(19) United States
(12) Patent Application Publication
(10) Pub. No.: US 2022/0082330 A1
(43) Pub. Date: Mar. 17, 2022

(54) HEAT EXCHANGER FOR FLAMMABLE REFRIGERANTS

(71) Applicant: Faiveley Transport Leipzig GmbH & Co. KG, Schkeuditz (DE)

(72) Inventors: Lutz Boeck, Schkeuditz (DE); Steffen Poser, Krostitz (DE); Erik Hoffmann, Borsdorf (DE); Kai Fischer, Leipzig (DE)

(21) Appl. No.: 17/419,696

(22) PCT Filed: Jan. 27, 2020
(86) PCT No.: PCT/DE2020/100049

§ 371 Date: Jun. 29, 2021

(30) Foreign Application Priority Data
Jan. 29, 2019 (DE) 202019100529.7

(51) Int. Cl. F28D 1/047; F28F 9/00; F28F 9/013

(52) U.S. Cl. CPC F28D 1/0475; F28D 2021/0085; F28F 9/013; F28F 9/001

(57) ABSTRACT

A heat exchanger for flammable refrigerants has a housing in which refrigerant lines are situated. The housing is provided with fins on the inside of a closed side face, and at least a portion of the outside of the closed side face can be brought into operative connection with a passenger compartment of a vehicle. The housing is designed as a module which can be partitioned off from the passenger compartment in a gas-tight manner, where only permanently sealed sections of the refrigerant lines are situated in the interior of the housing, the connection points of which refrigerant lines are each situated completely outside the housing. The housing has sealing frame and/or sealing plates such that the connections of the refrigerant lines are sealed off from the passenger compartment and are ventilated outward to the surroundings.

### CROSS-REFERENCE TO RELATED APPLICATIONS

This application is a national stage entry of International Patent Application No. PCT/DE2020/100049 entered pursuant to 35 U.S.C. § 371, which was filed on 27 Jan. 2020, and which claims priority to German patent application 202019100529.7, which was filed on 29 Jan. 2019. The entire disclosures of these applications are incorporated herein by reference.

### BACKGROUND

### Technical Field

The present invention relates to a heat exchanger for flammable refrigerants, preferably for a rail vehicle. The heat exchanger can have a hollow cuboid housing with refrigerant lines situated inside the housing. The refrigerant lines are designed as a tube-and-fin pack or as a tube-in-tube and fin pack. The hollow cuboid housing is provided with fins on the inside of a closed side face. At least a portion of the outside of the closed side face can be brought into operative connection with the passenger compartment.

### Discussion of Art

Flammable refrigerants have not been used to date for air conditioning in rail vehicles because of the associated risks, in particular the risks of explosion and fire. One possibility for minimizing these risks and thereby enable the use of flammable refrigerants in rail vehicles is to apply secondary circuit systems. In this case, the required cooling (or heating) power is provided in a primary circuit, which is located outside the vehicle and has no direct connection to the vehicle interior, using a flammable refrigerant in a known compression refrigeration circuit. This cooling power is transferred to a secondary circuit by means of a heat exchanger. This secondary circuit is typically a brine circuit, using water-glycol mixtures, for example, as refrigerant.

DE 196 25 927 C2 describes a device for heating and cooling a bus with an air conditioning system with a primary refrigerant circuit. The refrigerating machine with the primary refrigerant circuit is arranged under the floor of the passenger compartment. The primary refrigerant circuit is in operative connection with a secondary refrigerant circuit via an intermediate heat exchanger. This secondary refrigerant circuit is largely located in the interior of the bus and is used to control the temperature in the passenger compartment.

A cooling device for a work vehicle is known from EP 1 520 737 A1. A primary refrigerant circuit is arranged outside the work cabin and is in operative connection with a secondary refrigerant circuit via an intermediate heat exchanger. The secondary refrigerant circuit is arranged predominantly in the interior of the work cabin and takes over its temperature control.

WO 2018/137 908 A1 relates to a rail vehicle with a primary refrigerant circuit arranged outside the vehicle and structurally separated from the passenger compartment. A secondary refrigerant circuit is arranged at least partially inside the rail vehicle. The heat exchange between the primary refrigerant circuit and the secondary refrigerant circuit takes place via an intermediate heat exchanger, which is preferably arranged under the floor. As a result, the primary refrigerant circuit is routed completely outside the interior of the rail vehicle.

Such an air-conditioning system design makes good use of the available free installation space. Furthermore, refrigerants can be used for the circuit outside the passenger compartment which, for safety reasons, are not or hardly ever used for air conditioning in passenger compartments to avoid problems caused by uncontrolled leakage of the refrigerant in the event of malfunctions. This applies, for example, to propane, which is very suitable as a refrigerant from a functional point of view but is hardly ever used because of its flammability.

However, such designs also have significant disadvantages:
thermal losses that occur due to the use of a secondary circuit;
poorer efficiency and higher energy consumption;
a higher mass due to the additional internal heat exchanger and the necessary refrigerant; and
increased costs due to the additionally required components.

### BRIEF DESCRIPTION

One problem solved by the invention is to create a heat exchanger for an air conditioning system with which the existing safety risks of previous heat exchangers are avoided, so that secondary circuits can be dispensed with and where a direct system can instead be implemented. This heat exchanger should preferably be suitable for a rail vehicle.

One problem that is solved in that the heat exchanger has a hollow cuboid housing which is designed as an module which can be partitioned off from the passenger compartment in a gas-tight manner, where only permanently sealed sections of the refrigerant lines are arranged in the interior of the hollow cuboid housing. The connection points of the refrigerant lines are in each case arranged completely outside the hollow cuboid housing. The hollow cuboid housing is provided with at least one sealing frame and/or with at least two sealing plates in such a way that, when the heat exchanger is fixed in the installation position, the connections of the refrigerant lines are arranged in a region which is tightly partitioned off from the passenger compartment and is ventilated outwards to the surroundings.

In a first variant, the sealing frame is formed by two closed side walls arranged opposite each other and two end walls arranged perpendicularly to the side walls and opposite each other on the open surfaces of the hollow cuboid housing. In this case, the hollow cuboid housing is provided with a sealing coating on each of the two end wall surfaces.

In a second variant, the sealing frame is formed by a separating segment which is arranged on the closed side face, which is designed with a circumferential flange.

This creates a heat exchanger for an air-conditioning system that enables the use of flammable refrigerants in a direct-evaporation system, preferably a heat exchanger for rail vehicles. The entire air duct to the passenger compartment is designed to be pressure- and gas-tight with respect to the refrigerant-carrying areas, so that a reliable seal is ensured between the passenger compartment and the flammable refrigerant.

One embodiment provides that the refrigerant lines are each separately mounted and sealed on the opposing open end walls of the hollow cuboid housing.

The tube-and-fin pack is considered to be permanently sealed. In an embodiment of the heat exchanger with a tube-and-fin pack, only this tube-and-fin pack is located in the air flow to the passenger compartment and is thus connected to it by a direct route. All other components of the refrigeration circuit (tubes, joints and other components) are located outside the air path to the passenger compartment and are separated from it in a gas-tight manner.

In one embodiment, the refrigerant lines are designed as a tube-in-tube arrangement in such a way that the inner tube is designed as a tube with multiple circumferential coils and that each tube coil section in the hollow cuboid housing is enclosed by a respective outer tube. Each outer tube is open on both sides and ensures leakage drainage into the outer surrounding area in the event of a fault. In the event of leakage from the inner tube, the escaping gaseous refrigerant in the outer tube would be conducted to the outside in an area separated from the passenger compartment in a gas-tight manner, thus preventing it from entering the air duct to the passenger compartment.

Moreover, the tube-in-tube arrangement can be designed in such a way that the inner tube has a ribbing which is preferably straight or cylindrically twisted. This ribbing allows mechanical and thermal contact with the outer tube after expansion, wherein a free air space remains.

With the technical features described above, a heat exchanger can be designed in three basic variants:

In the first variant, two different designs are possible for the sealing and the holding of the tubes. For example, a rubber or alternatively a plastic wall can be provided on the inside of the sheet metal plate, or a plastic bushing can be provided to guide/seal the tube in the sheet metal plate. This is possible both for the simple tube design and for the tube-in-tube design.

In the second variant, the sheet metal is arranged on the outside for holding and the rubber or plastic is arranged on the inside. In doing so, in both variants, the tubes can be implemented both as a simple tube or as a tube-in-tube design. In this second variant, there is no need to have a coating on the inside or plastic bushing for sealing the tubes on the outside retaining sheet. In this design, the sealing function is performed by the rubber on the inside.

In the third variant, two sheet metal parts are used instead of a combination of sheet metal and rubber or plastic elements. The sealing plates provided here, as an alternative or supplement to a sealing frame, are each arranged on the opposite end walls, on the open surfaces of the hollow cuboid housing. These sealing plates, in relation to the interior of the hollow cuboid housing, are arranged within a retaining plate forming the supporting structure of the end wall and are fastened to the hollow cuboid housing by a circumferential elastic connection in the form of a flexible sealing seam.

The sealing plates each have openings for the feedthrough of the refrigerant lines. The openings in the sealing plates are produced by punching, laser cutting or drilling and are designed in such a way that expanded refrigerant lines can be inserted in these openings. Likewise, the openings in the sealing plates can be designed with a pull-through as a collar to accommodate expanded refrigerant lines.

### BRIEF DESCRIPTION OF THE DRAWINGS

In the following, an embodiment example of the invention is explained in more detail with reference to the following drawings:

FIG. 1 shows a first embodiment of the heat exchanger from a side view;

FIG. 2 shows the heat exchanger according to FIG. 1 from a perspective view;

FIG. 3 shows a second embodiment of the heat exchanger from a side view;

FIG. 4 shows the heat exchanger according to FIG. 3 from a perspective view;

FIG. 5 shows a third embodiment of the heat exchanger from a side view;

FIG. 6 shows a detail of the heat exchanger according to FIG. 5 in an enlarged view in two alternative embodiments; and

FIG. 7 shows a fourth embodiment of the heat exchanger from a perspective view.

### DETAILED DESCRIPTION

The heat exchanger shown in the drawings is suitable for air conditioning systems with a direct refrigerant circuit and is primarily conceived for a rail vehicle. Such a design principle is already known. In the present case, however, the specific implementation of the basic idea is fundamental. Consequently, the heat exchanger comprises a gas-tight sealable module which is functionally designed as an element for ducting of the air to the passenger compartment. This module has a hollow cuboid housing with sealing elements.

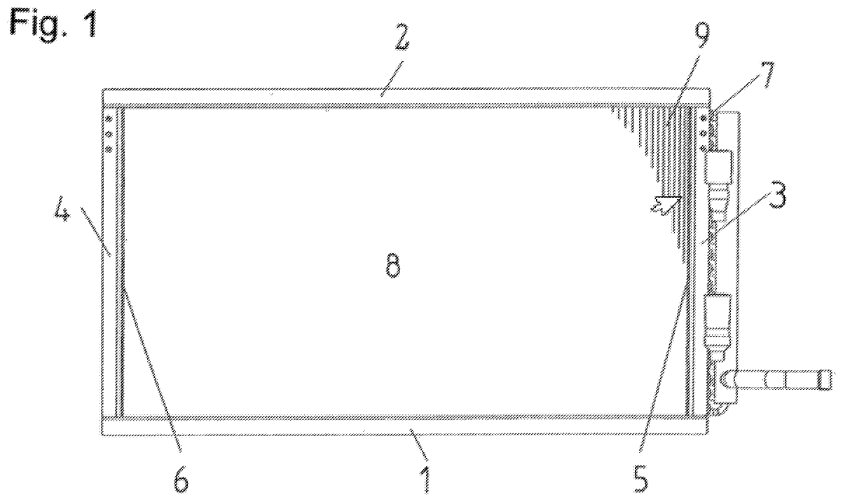

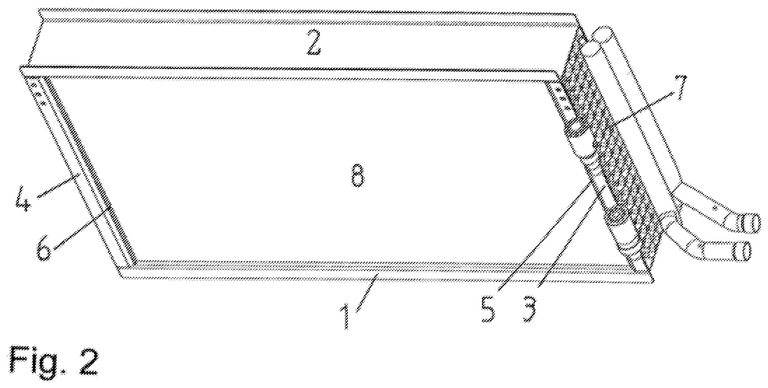

According to FIG. 1 and FIG. 2, a sealing frame in a heat exchanger with a tube-and-fin pack is formed by two closed side walls 1 and 2. The side walls are arranged opposite each other and two end walls 3 and 4 are arranged perpendicular to the walls 1 and 2 and opposite each other at the end faces of the hollow cuboid housing. The wall surfaces are each provided with a sealing coating. According to FIG. 1, the end wall 3 has a sealing coating 5 and the end wall 4 has a sealing coating 6 for this purpose.

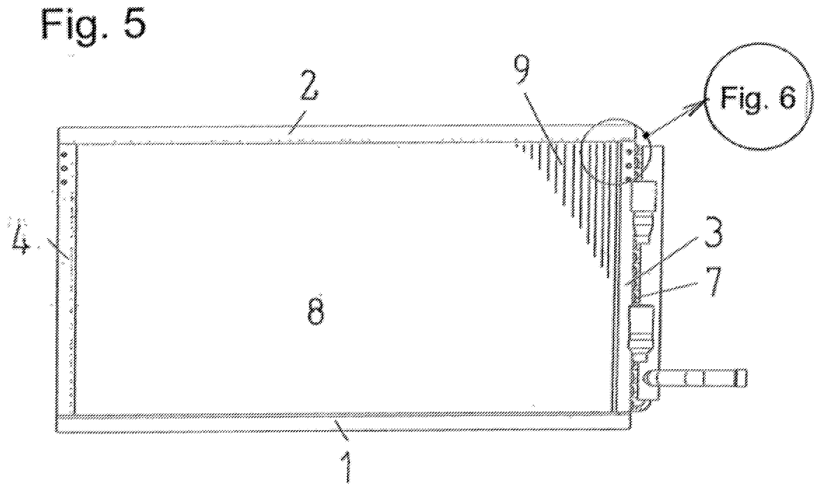

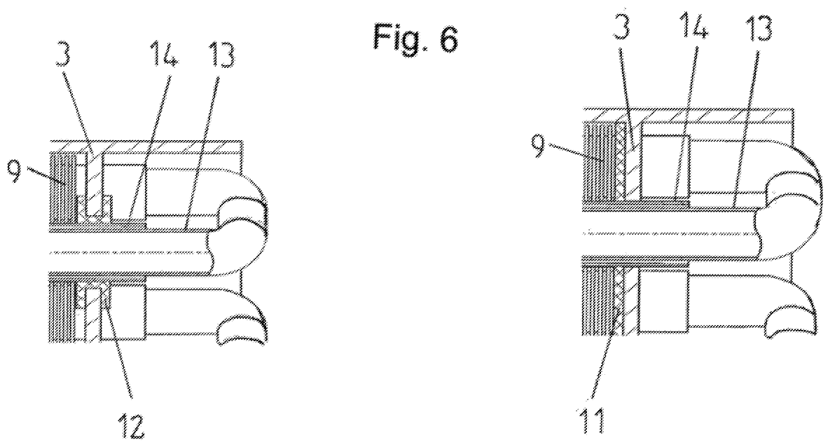

Only sections of refrigerant lines that are permanently gas-tight are arranged in the interior of the hollow cuboid housing. These can alternatively be designed as a tube-and-fin pack (FIG. 1 through FIG. 4) or as a tube-in-tube arrangement (FIG. 5 and FIG. 6). The corresponding pack of tubes is designated by reference sign 7. The connections of the refrigerant lines are each arranged completely outside the hollow cuboid housing.

The hollow cuboid housing is provided with fins on the inside of a side surface 8 which runs perpendicularly to the two closed side walls 1 and 2 and is also closed. The corresponding set of fins is designated by the reference sign 9. At least a portion of the outside of the closed side face 8 is brought into operative connection with the passenger compartment, which is not shown in greater detail, in such a way that, when fixed in the installation position of the hollow cuboid housing, the connections of the refrigerant lines are arranged in an area partitioned off from the passenger compartment in a gas-tight manner.

The refrigerant lines are mounted separately on the opposing open end walls of the hollow cuboid housing and sealed separately. This can be achieved in various ways. For example, a sheet metal plate arranged on the end face can be provided for supporting the refrigerant lines. Sealing can be achieved, for example, via a sealing coating or via seals or via plastic elements. Regardless of the specific design, the necessary functional reliability is achieved by separating the sealing and holding functions.

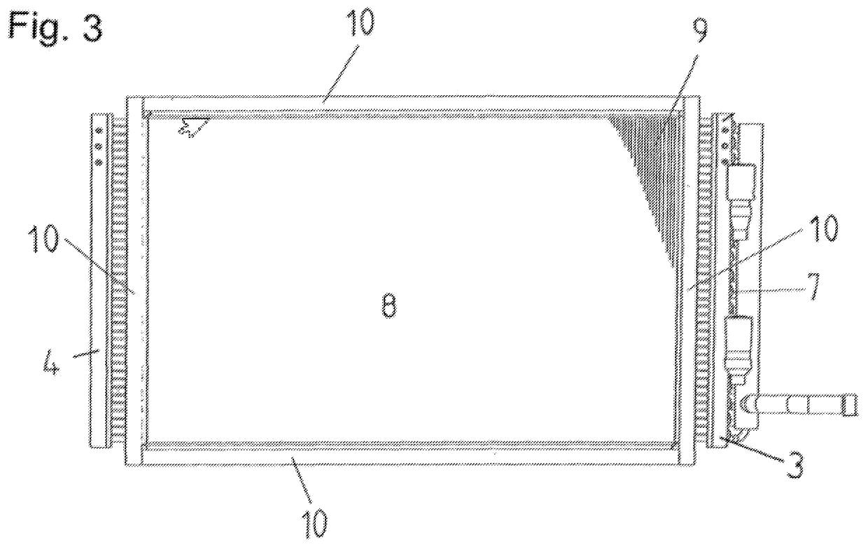

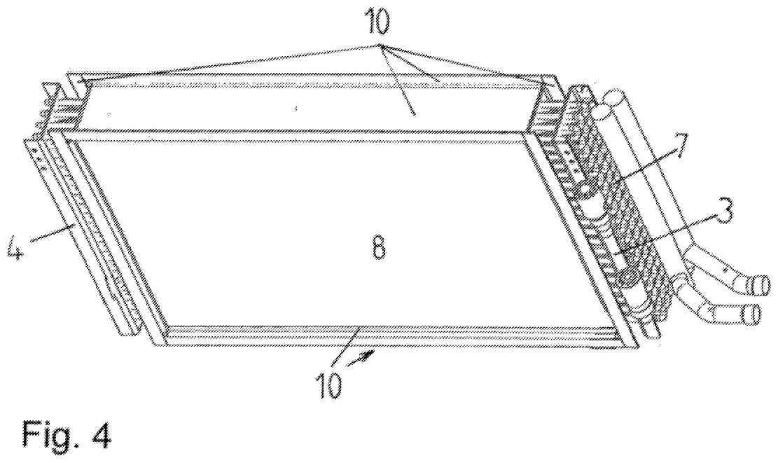

FIG. 3 and FIG. 4 show a somewhat modified design of the heat exchanger with a hollow cuboid housing. The refrigerant lines are also designed as a tube-and-fin pack. However, the sealing frame is formed here by a separating segment 10, which is arranged on the closed side face 8 and is designed with a circumferential flange. This separating segment 10 is preferably made of a hard rubber material and has partially reinforced flange connections.

In this design according to FIG. 3 and FIG. 4, the two end walls 3 and 4 have a sealing function. Thus, the sealing frame is the outwardly (air direction) visible area of the rubber part marked with the reference sign 10. The end plates take on a supporting function here and each constitutes a wall on the right and left.

FIG. 5 shows a heat exchanger with refrigerant lines in a tube-in-tube and fin pack design. The basic structure corresponds largely to the design shown in FIG. 1 and FIG. 2. Consequently, the sealing frame is formed by two closed side walls 1 and 2 arranged opposite each other and two end walls 3 and 4 arranged perpendicularly to the side walls 1 and 2 and opposite each other on the open surfaces of the hollow cuboid housing. The heat exchanger also comprises a tube pack 7 in the interior of the hollow cuboid housing and the fin pack 9 arranged on the inner side of the closed side face 8.

In this tube-in-tube and fin pack, the inner tube 13 is designed as a tube with multiple circumferential coils. Each tube coil section is enclosed in the hollow cuboid housing by an outer tube 14, the end faces of which are open.

FIG. 6 shows details of the effective connection for sealing the tube feedthrough, illustrated here using the example of the design with inner tube 13 and outer tube 14. The sealing of the tube feedthrough can also be implemented in the same way for a single tube. In the right figure, the sealing element is designed as an area seal 11 and in the left figure, the sealing element is designed as an annular seal 12.

Furthermore, the inner tube 13 has a ribbing, not shown in the drawing, for thermal contact with the outer tube 14. This ribbing can, for example, be straight or turned cylindrically. The open end faces of the outer tube 14 enable leakage discharge in the event of a fault, which represents a significant safety advantage over known designs, particularly when flammable refrigerants (e.g. propane) are used.

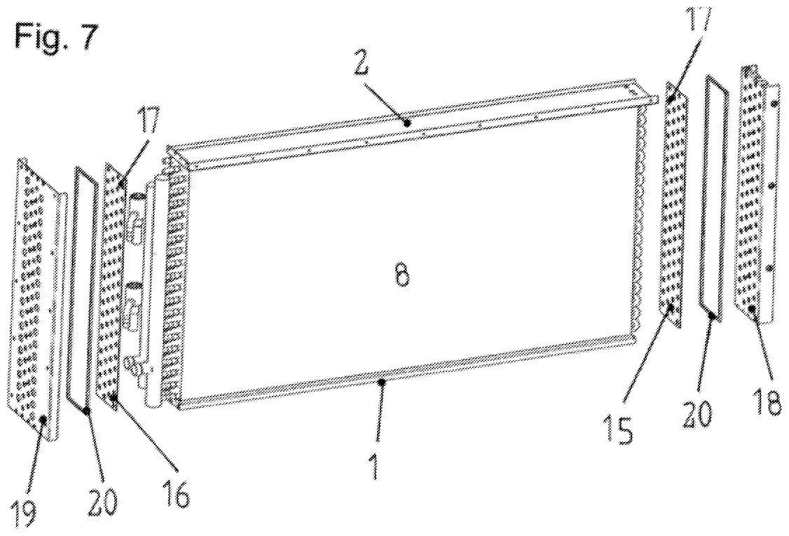

FIG. 7 shows a further design of the heat exchanger with a hollow cuboid housing, which is functionally designed as an element for ducting air to the passenger compartment. In the variant shown here, the refrigerant lines are also designed as a tube and fin pack. Instead of a sealing frame, however, two sealing plates 15 and 16 are used to form a gas-tight sealable module. The sealing plates 15 and 16 are each arranged at the end of the fin stack and have no rigid connection to the supporting structure of the heat exchanger. Thus, the functions of holding and sealing are separate from one another and are accomplished using different components.

To ensure a sufficient adhesive base (joint for the sealant), the sealing plates 15 and 16 are designed with a projection that runs around the circumference in relation to the outer dimensions of the fins to the edge areas and tube areas. The sealing plates 15 and 16 are designed to be at least as large as the fin dimensions. As long as they are designed to be larger in height, the sealing of the fin pack is achieved by adjusting the seal between the upper side wall 1 and/or the lower side wall 2 of the heat exchanger. Provided that the side walls 1 and/or 2 of the heat exchanger are designed to be demountable, a subsequent sealing of the sealing plates 15 and 16 is possible in a simple manner.

The sealing plates 15 and 16 have openings 17 for the feedthrough of the refrigerant lines of the tube packs 7. The openings 17 are designed in such a way that expanded refrigerant lines can be inserted in them. This ensures that the two sealing plates 15 and 16 are firmly and tightly seated on the refrigerant lines. This can be achieved by forming punched openings 17, laser-cut openings 17 or drilled openings 17 in the sealing plates 15 and 16 as feedthroughs for the tubes.

Similarly, the sealing plates 15 and 16 can be designed with sections of turned fins in the tube feedthrough in conjunction with expanded refrigerant lines. With turned fins, better bearing support is achieved for the refrigerant line feedthrough by allowing alignment of the pull-through collars of the fin tube openings to the respective sealing plate 15 or 16.

Furthermore, the openings 17 with a pull-through can be designed as collars for receiving expanded refrigerant lines. This provides a better cylindrical support for the refrigerant lines, which enables a reduced notch effect and a better sealing effect.

In the embodiment according to FIG. 7, the end walls are each designed as separate components in the form of retaining plate 18 and 19. These retaining plates 18 and 19 functionally form the supporting structure of the respective end wall.

One of the two sealing plates 15 and 16 is provided on each of the opposing open surfaces of the hollow cuboid housing, these sealing plates 15 and 16 being arranged inside the retaining plates 18 and 19 with respect to the interior of the hollow cuboid housing. The consequently externally arranged retaining plates 18 and 19 have openings through which both ventilation to and pressure equalization with the outside surroundings are possible.

In the assembled state, the sealing plates 15 and 16 are preferably attached to the hollow cuboid housing via a circumferential elastic connection designed as a flexible sealing seam 20 and thereby do not have a direct fixed connection to the supporting structure of the heat exchanger.

Irrespective of the specific design of the seal, the circumferential sealing seam is permanently fixed and sealed against pressure fluctuations or pressure waves up to at least +/−10 kPa.

The free area between the sealing plates 15 and 16 arranged on both sides and the supporting outer side walls of the heat exchanger can be designed in various ways, for example by a sealing mat inserted in the cavity, by a circumferentially elastic injected adhesive, or by filling the entire cavity with an elastic sealing compound or with a seal glued in on one side. Furthermore, an additional sealing is possible, for example, with a temperature-resistant fleece between the sealing plates 15 and 16 and the retaining plates 18 and 19. The actual sealing to create a sealable area is then performed via the retaining plates 18 and 19 when the heat exchanger is in the fixed installation position relative to the housing.

1. A heat exchanger for flammable refrigerants, the heat exchanger comprising:
a housing;
refrigerant lines disposed inside the housing, wherein the housing includes fins on an inside of a closed side face of the housing, at least a partial region of an outside of the closed side face is configured to operatively connect with a passenger compartment of a vehicle,
wherein the housing is designed as an module which can be partitioned off from the passenger compartment in a gas-tight manner, wherein only permanently sealed sections of the refrigerant lines are arranged inside the housing, wherein connection points of the refrigerant lines are arranged completely outside the housing, and wherein the housing includes one or more of: at least one sealing frame or at least two sealing plates that, while the heat exchanger is fixed in an installation position of the vehicle, the connection points of the refrigerant lines are arranged in a region which is partitioned off from the passenger compartment and are ventilated outward to surroundings of the vehicle.

2. The heat exchanger according to claim 1,
wherein the sealing frame is formed by closed side walls arranged opposite each other and end walls arranged perpendicular to the side walls and opposite each other on open surfaces of the housing.

3. The exchanger according to claim 1,
wherein the sealing frame is formed by a separating segment arranged on a closed side face of the housing, the sealing frame having a circumferential flange that includes a hard rubber or plastic material and has partially reinforced flange connections.

4. The heat exchanger according to claim 1,
wherein the housing has a sealing coating on each of end walls of the housing while the refrigerant lines are designed as a tube-and-fin pack.

5. The heat exchanger according to claim 1,
wherein the refrigerant lines are separately mounted and separately sealed on opposing open end walls of the housing, wherein the sealing elements are designed as an area seal or as an individual annular seal.

6. The heat exchanger according to claim 1,
wherein the refrigerant lines are designed as a tube-in-tube and fin pack in such a way that an inner tube of the refrigerant lines is designed as a tube with multiple circumferential coils, wherein each tube coil section of the coils is enclosed by a respective outer tube and wherein each of the outer tubes has an open-end face outside the housing.

7. The heat exchanger according to claim 1,
wherein the refrigerant lines are designed in a tube-in-tube and fin pack configuration such that an inner tube of the refrigerant lines has a ribbing for thermal contact with an outer tube of the refrigerant lines.

8. The heat exchanger according to claim 1, wherein the housing includes the at least two
sealing plates, the at least two sealing plates having openings for feedthrough of the refrigerant lines, the at least two sealing plates arranged on each of opposing end walls of the housing on open surfaces of the housing, wherein the at least two sealing plates are arranged with respect to the interior of the housing within a retaining plate forming a supporting structure of at least one of the end walls and being fastened to the housing by an elastic connection.

9. The heat exchanger according to claim 8,
wherein the at least two sealing plates are fastened to the housing via a circumferential flexible sealing seam.

10. The heat exchanger according to claim 8,
wherein a free area between the at least two sealing plates and supporting side walls of the sealing frame is formed by a sealing mat inserted in a cavity, by circumferentially elastic injected adhesive, or by a filling in the cavity by an elastic sealing compound or with a glue seal.

11. The heat exchanger according to claim 8,
further comprising:
an additional seal formed with a temperature-resistant fleece which is arranged between the at least two sealing plates and the retaining plate.

12. The exchanger according to claim 8,
wherein openings in the at least two sealing plates are sized to receive the refrigerant lines while the refrigerant lines are expanded.

13. The heat exchanger according to claim 8,
wherein openings in the at least two sealing plates are provided with a pull-through as a collar for receiving the refrigerant lines.

14. The heat exchanger according to claim 8,
wherein sections of the fins are arranged in openings in the at least two sealing plates.

15. The heat exchanger according to claim 8, further comprising:
retaining plates having ventilation and pressure compensation openings.

16. The heat exchanger according to claim 1, wherein the housing is a hollow cuboid housing.
